(19) United States
(12) Patent Application Publication
(10) Pub. No.: US 2017/0220367 A1
(43) Pub. Date: Aug. 3, 2017

(54) OFFLINE HADOOP DEPLOYMENT ANOMALY IDENTIFICATION

(71) Applicant: VMware, Inc., Palo Alto, CA (US)

(72) Inventors: Xinhui LI, Beijing (CN); Luke LU, Palo Alto, CA (US); Sheng LU, Beijing (CN)

(73) Assignee: VMware, Inc., Palo Alto, CA (US)

(21) Appl. No.: 15/011,480

(22) Filed: Jan. 30, 2016

(51) Int. Cl. G06F 9/455; H04L 12/24; G06F 17/30

(52) U.S. Cl. CPC G06F 9/45558; G06F 17/30203; H04L 41/0869; G06F 2009/45591; G06F 2009/45595

(57) ABSTRACT

A method includes receiving a trace of a job in a distributed computing system and a topology of the system and determining performance indicators of each virtual node's (1) busyness from executing its share of local resource and network dependent tasks in the job, (2) efficiency for executing its share of the local resource tasks, and (3) efficiency for executing its share of the network dependent tasks. The method includes aggregating performance indicators of each host's virtual nodes and determining if one of the hosts is least efficient in executing its share of the local resource and the network dependent tasks. If so, the method includes determining if the one host is less busy from executing it share of the local resource and the network dependent tasks than other hosts. If not, the method includes reporting the one host's busiest virtual node as a candidate of processor error.

### BACKGROUND

Virtualization allows the abstraction of hardware resources and the pooling of these resources to support multiple virtual machines. For example, through virtualization, virtual machines with different operating systems may be run on the same physical machine. Each virtual machine is provisioned with virtual resources that provide similar functions as the physical hardware of a physical machine, such as central processing unit (CPU), memory, and network resources to run an operating system and different applications.

Hadoop is a distributed computing framework for running applications on a large cluster of nodes implemented with commodity hardware. Hadoop provides a distributed file system (HDFS) that stores data on the nodes, allowing it to store large files. Hadoop implements a computational paradigm named MapReduce that divides a large data processing job into many small map and reduce tasks and executes them on nodes that either have the data or are near those with the data.

A virtual Hadoop is a Hadoop implemented on a virtualization platform where virtual machines contain various Hadoop roles such as JobTracker, NameNode, Secondary NameNode, TaskTracker, and DataNode daemons. The names for the Hadoop roles may be different depending on the Hadoop version, and some roles may be further split or combined depending on the Hadoop version. Some benefits from virtualizing Hardoop include enhanced availability, easy deployment, and better resource utilization.

### BRIEF DESCRIPTION OF THE DRAWINGS

FIG. 1 is a block diagram illustrating a simplified view of a virtual machine (VM) system implementing a virtual Hadoop in examples of the present disclosure.

FIGS. 2-1 and 2-2 show a flowchart of a method performed by a configuration analyzer to identify a possible anomaly in a virtual Hadoop in examples of the present disclosures; and

FIGS. 3-1 and 3-2 show a flowchart of a method performed by a configuration analyzer to identify a possible anomaly in a virtual Hadoop in examples of the present disclosures.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated herein.

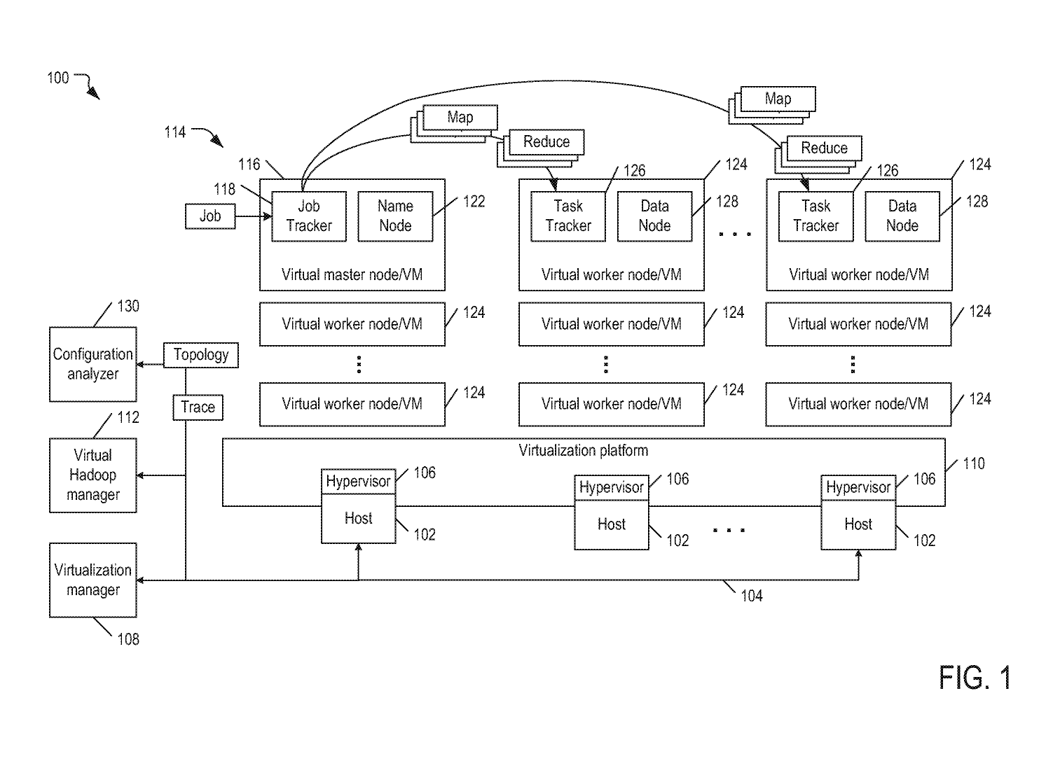

FIG. 1 is a block diagram illustrating a simplified view of a virtual machine (VM) system 100 in examples of the present disclosure. VM system 100 includes virtualization host computers 102, also referred to as hosts 102. Hosts 102 are coupled through a network 104. Each host 102 includes physical memory, processor, local storage, and network interface cards (NICs). Each host 102 runs a hypervisor 106 to create and run VMs. A virtualization manager 108 centrally provisions and manages virtual and physical objects in VM system 100, such as VMs, clusters, and hosts. Virtualization manager 108 may run on one of hosts 102 or a dedicated host (not shown) coupled by network 104 to hosts 102. Together hypervisors 106 and virtualization manager 108 provide a virtualization platform 110 that can implement information technology services such as web services, database services, and data processing services. VM system 100 may be a VMware datacenter, hypervisor 106 may be a VMware vSphere ESXi hypervisor, and virtualization manager 108 may be a VMware vCenter Server.

A virtual Hadoop manger 112 communicates with virtualization manager 108 to deploy, run, and manage a virtual Hadoop 114. Virtual Hadoop manager 112 requests VM manage 108 to use templates to create VMs containing various Hadoop roles, such virtual master nodes containing JobTracker and NameNode daemons, and virtual worker nodes containing TaskTracker and DataNode daemons. Virtual Hadoop manager 112 and the templates may be a virtual appliance, such as the Big Data Extensions for the VMware vSphere virtualization platform. Virtualization Hadoop manager 112 may run on one of hosts 102 or a dedicated host (not shown) coupled by network 104 to hosts 102. Although Hadoop is specifically mentioned, the present disclosure is applicable to different versions Hadoop as well as other distributed computing systems.

Virtual Hadoop manager 112 creates a virtual master node 116 running a JobTracker 118 and a NameNode 122, and a large number of virtual worker nodes 124 each running a TaskTracker 126 and a DataNode 128. Although shown on one virtual master node 116, JobTracker 118 and Name Node 122 may run on separate master nodes on the same or separate hosts 102. Multiple virtual worker nodes 124 may run the same host 102 or different hosts 102.

When JobTracker 118 receives a job to process certain data, JobTracker 118 splits the job into map tasks and reduce tasks, communicates with NameNode 122 to determine virtual worker nodes with the data, determines TaskTrackers at or near these virtual worker nodes, and submits the map tasks to these TaskTrackers. Once these TaskTrackers complete their map tasks, they store intermediate data in local storage. JobTracker 118 submits the reduce tasks to other TaskTrackers, which retrieve the intermediate data over the network (virtual or physical) from the completed map tasks, combine the intermediate data, and store the results. Note that the map tasks relies on local resources as they process local data so they are considered local resource tasks, and reduce tasks rely on network resources as they retrieve remote data so they are considered network dependent tasks.

As part of processing a job, JobTracker 118 records job statistics in a job history log or trace. The job trace includes information about the job, such as the job's identifier and start/end times (used to calculate time duration of the job). The job trace also includes information for each task in the job, such as the task's identifier, type (map or reduce), number of CPU ticks to complete the task, and start/end times (used to calculate time duration of the task).

After creating virtual Hadoop 114, it is desirable to perform a sanity check on the deployment to ensure virtual Hadoop 114 operates properly. However, the sanity check should not depend on third party monitoring tools, which may increase overhead and cost. Furthermore, the sanity check should not depend on any specific Hadoop distribution (version or vendor). The sanity check should identify a virtual node or host as a candidate of configuration error and identify a type of configuration error, such as a central processing unit (CPU), disk, or network configuration error.

In examples of the present disclosure, VM system 100 includes a configuration analyzer 130 that identifies any anomaly in virtual Hadoop 114. Configuration analyzer 130 uses a job trace and the topology of virtual Hadoop 114 to find a candidate of configuration error. The candidate may be a host or a virtual node, which is typically a virtual worker node but may be a virtual master node if it includes a TaskTracker or DataNode. The configuration error may be a CPU, disk, or network configuration error. Configuration analyzer 130 may be a virtual appliance. Configuration analyzer 130 may run on one of hosts 102 or a dedicated host (not shown) coupled by network 104 to hosts 102.

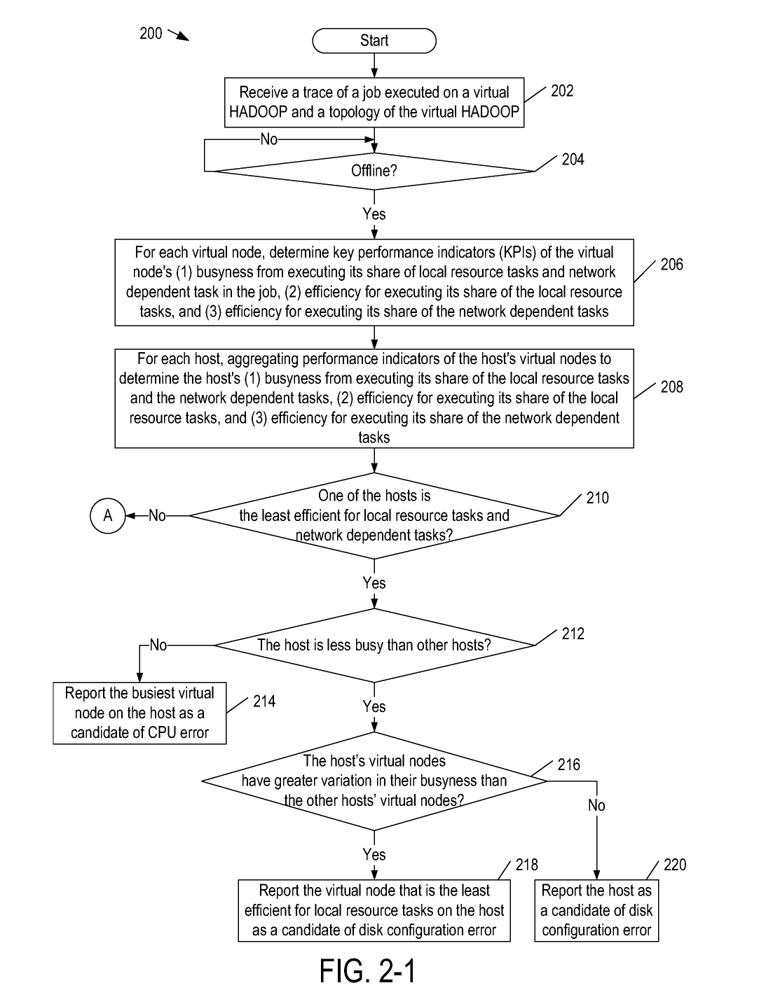

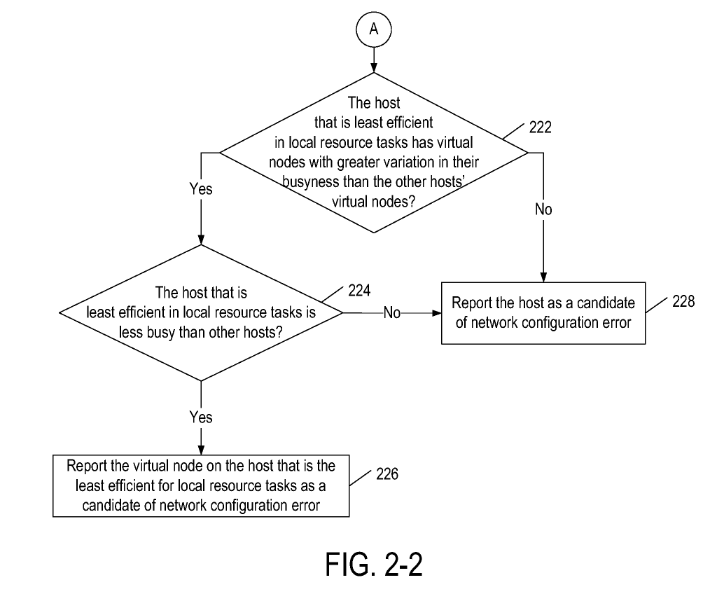

FIGS. 2-1 and 2-2 show a block diagram of a method 200 for configuration analyzer 130 to identify a possible anomaly in virtual Hadoop 114 having virtual worker nodes 124 that are VMs on hosts 102 in examples of the present disclosure. Method 200 may be executed by a processor of a host executing computer readable codes of configuration analyzer 130. Method 200 may begin in block 202 of FIG. 2-1.

In block 202, configuration analyzer 130 receives a trace of a job executed on virtual Hadoop 114 and the topology of the virtual Hadoop. The job may be a benchmark representing real Hadoop workloads. The job includes local resource tasks and network dependent tasks. Configuration analyzer 130 receives the trace from JobTracker 118 after the job is completed. The trace identifies particular local resource tasks and network dependent tasks performed on each virtual worker node, the number of CPU ticks used to perform each task, the time duration for completing each task, and the time duration for completing the job. The topology of virtual Hadoop 114 identifies the mappings between virtual worker nodes 124 and hosts 102. Configuration analyzer 130 receives the topology of virtual Hadoop 114 from virtualization manager 108 or virtual Hadoop manager 112. Block 202 may be followed by block 204.

In block 204, configuration analyzer 130 may determine if virtual Hadoop 114 is offline. If so, configuration analyzer 130 may proceed to block 206 to identify a possible anomaly in virtual Hadoop 114. Otherwise, configuration analyzer 130 may loop back to block 202 to avoid affecting the performance of virtual Hadoop 114.

In block 206, configuration analyzer 130 uses the trace to determine, for each virtual worker node 124, key performance indicators (KPIs) of the virtual worker node. The KPIs indicate a virtual worker node's (1) busyness from executing its share of the local resource tasks and the network dependent tasks in the job, (2) efficiency for executing its share of the local resource tasks in the job, and (3) efficiency for executing its share of the network dependent tasks in the job. Block 206 may be followed by block 208.

In block 208, configuration analyzer 130 determines which virtual worker nodes 124 are located on which hosts 102 and then aggregates, for each host 102, KPIs of the host's virtual worker nodes. The aggregated KPIs indicate a host's (1) busyness from executing its share of the local resource tasks and the network dependent tasks in the job, (2) efficiency for executing its share of the local resource tasks in the job, and (3) efficiency for executing its share of the network dependent tasks in the job. Block 208 may be followed by block 210.

In block 210, configuration analyzer 130 uses the aggregated KPIs of hosts 102 to determine if one of hosts 102 is the least efficient in both executing its share of the local resource tasks and its share of the network dependent tasks. If so, an anomaly may exist in a host or a VM's local resource configuration and block 210 may be followed by block 212. Otherwise, an anomaly may exist in a host or a VM's network configuration and block 210 may be followed by block 222 (FIG. 2-2).

In block 212, configuration analyzer 130 determines if the one host determined in block 210 is less busy from executing its share of the local resource tasks and the network dependent tasks than other hosts. If not, an anomaly may exist in a VM's processor configuration and block 212 may be followed by block 214. Otherwise, an anomaly may exist in a host or a VM's disk configuration and block 212 may be followed by block 216.

In block 214, configuration analyzer 130 reports the one host's busiest virtual worker node as a candidate of processor error. Configuration analyzer 130 may report a candidate for any kind of error by generating an onscreen alert, sending a message, or recording an entry in a log.

In block 216, configuration analyzer 130 determines if the one host's virtual worker nodes have greater variation in their busyness from executing their shares of the local resource tasks and the network dependent tasks than the other hosts' virtual worker nodes. If so, an anomaly may exist in a VM's disk configuration and block 216 may be followed by block 218. Otherwise, an anomaly may exist in a host's disk configuration and block 216 may be followed by block 220.

In block 218, configuration analyzer 130 reports the one host's least efficient virtual worker node in executing its share of the local resource tasks as a candidate of disk configuration error. Method 200 may end after block 218.

In block 220, configuration analyzer 130 reports the one host as a candidate of disk configuration error. Method 200 may end after block 218.

In block 222 of FIG. 2-2, configuration analyzer 130 determines if the host that is least efficient in executing its share of the local resource tasks (hereafter simply as “the host”) has virtual worker nodes with greater variation in their busyness than other hosts' virtual worker nodes. If so, block 222 may be followed by block 224. Otherwise, an anomaly may exist in a host's network configuration and block 222 may be followed by block 228.

In block 224, configuration analyzer 130 determines if the host is less busy than other hosts. If so, an anomaly may exist in a VM's network configuration and block 224 may be followed by block 226. Otherwise, an anomaly may exist in a host's network configuration and block 224 may be followed by block 228.

In block 226, configuration analyzer 130 reports the host's least efficient virtual worker node in executing its share of the local resource tasks as a candidate of network configuration error. Method 200 may end after block 226.

In block 228, configuration analyzer 130 reports the host that is least efficient in executing its share of the local resource tasks as a candidate of network configuration error. Method 200 may end after block 228.

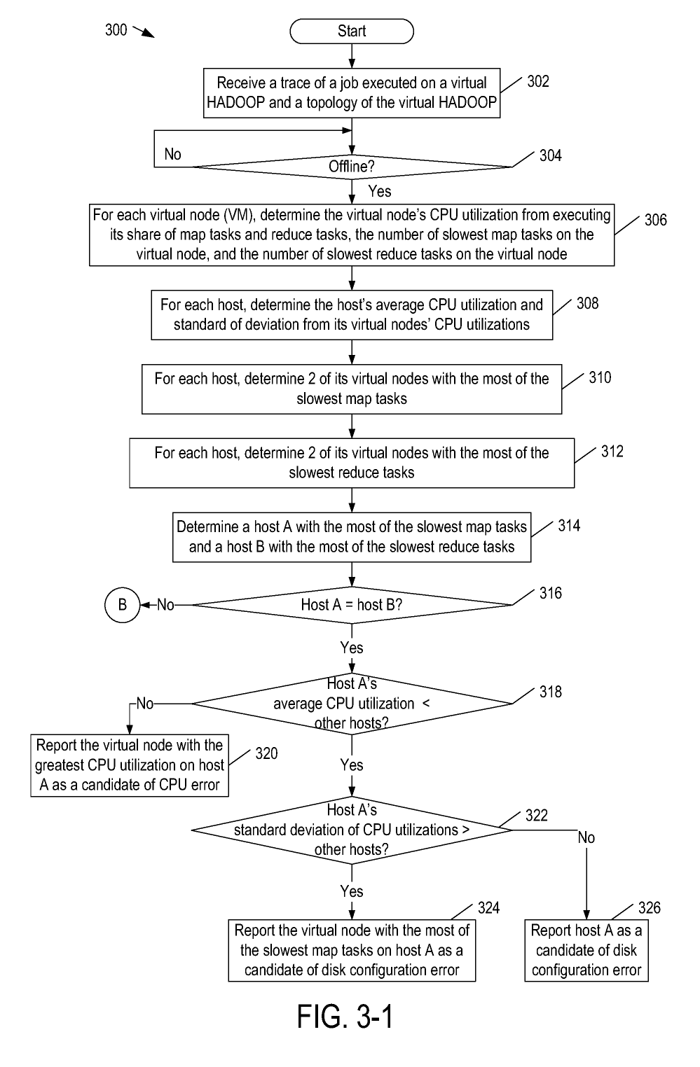

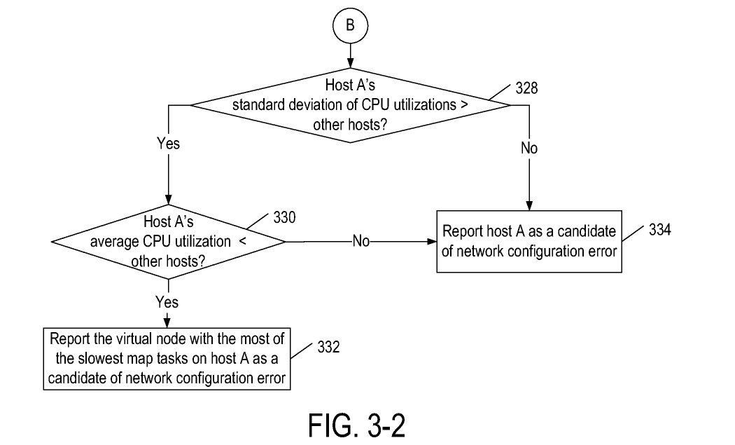

FIGS. 3-1 and 3-2 show a block diagram of a method 300 to identify a possible anomaly in virtual Hadoop 114 having virtual worker nodes 124 that are VMs on hosts 102 in examples of the present disclosure in examples of the present disclosure. Method 300 may be a variation of method 200. Method 300 may be executed by a processor of a host executing computer readable codes of configuration analyzer 130. Method 300 may begin in block 302 in FIG. 3-1.

In block 302, configuration analyzer 130 receives a trace of a job executed on virtual Hadoop 114 and the topology of the virtual Hadoop. Block 302 corresponds to block 202 of method 200 (FIG. 2-1). As described above, the job may be a benchmark representing real Hadoop workloads. The job includes local resource tasks and network dependent tasks. The trace identifies particular local resource tasks and network dependent tasks performed on each virtual worker node, the number of CPU ticks used to perform each task, the start/end times of each task (for calculating the time duration for completing each task), and the start/end times of the job (for calculating the time duration for completing the job). The topology of virtual Hadoop 114 identifies the mappings between virtual worker nodes 124 and hosts 102. Block 302 may be followed by block 304.

In block 304, configuration analyzer 130 determines if virtual Hadoop 114 is offline. If so, configuration analyzer 130 may proceed to block 306 to identify a possible anomaly in virtual Hadoop 114. Otherwise configuration analyzer 130 may loop back to block 302 to avoid affecting the performance of virtual Hadoop 114. Block 304 corresponds to block 204 of method 200 (FIG. 2-1).

In block 306, configuration analyzer 130 uses the trace to determine, for each virtual worker node 124, key performance indicators (KPIs) of the virtual worker node. The KPIs indicate a virtual worker node's (1) busyness from executing its share of the local resource tasks and the network dependent tasks in the job, (2) efficiency for executing its share of the local resource tasks in the job, and (3) efficiency for executing its share of the network dependent tasks in the job. The KPIs include a virtual worker node's (1) CPU utilization in executing particular map and reduce tasks from the job on the virtual worker node, (2) task execution duration efficiency in executing particular map tasks from the job on the virtual worker node, and (3) task execution duration efficiency in executing particular reduce tasks from the job on the virtual worker node.

A virtual worker node's CPU utilization is the total number of CPU ticks for all the map tasks and the reduce tasks on the virtual worker node divided by the total time duration for completing all the map tasks and the reduce tasks on the virtual worker node.

A virtual worker node's task execution duration efficiency in executing its share of the map tasks is the number of the slowest map tasks that are found on the virtual worker node. The slowest map tasks may be limited to a fixed number, such as the ten (10) slowest map tasks from all the map tasks in the trace. Alternatively, the slowest map tasks may be limited to a variable number, such as half of all the map tasks in the trace or the number of map tasks that take longer than a percentage (e.g., 85%) of the average task time. A virtual worker node's task execution duration efficiency in executing its share of the map tasks may be represented by “N1: Node-X” where “N1” is the number of the 10 slowest map tasks that are found on the virtual worker node X.

A virtual worker node's task execution duration efficiency in executing its share of the reduce tasks is the number of the slowest reduce tasks that are found on the virtual worker node. The slowest reduce tasks may be limited to the ten (10) slowest reduce tasks from all the reduce tasks in the trace. A virtual worker node's task execution duration efficiency in executing its share of the reduce tasks may be represented by “n1: Node-x” where “n1” is the number of the 10 slowest reduce tasks that are found on the virtual worker node x.

Block 306 may be followed by block 308. Block 306 corresponds to block 206 of method 200 (FIG. 2-1).

In block 308, configuration analyzer 130 determines which virtual worker nodes 124 are located on which hosts 102. Configuration analyzer 130 then aggregates, for each host 102, KPIs of the host's virtual worker nodes to determine KPIs of the host's busyness from executing its share of the map tasks and the reduce tasks of the job (i.e., particular map and reduce tasks of the job on the host). For example, configuration analyzer 130 determines, for each host 102, the host's average CPU utilization and magnitude and distribution of variances (e.g., standard deviation) of its virtual worker nodes' CPU utilizations. Block 308 may be followed by block 310.

In block 310, configuration analyzer 130 aggregates, for each host 102, KPIs of the host's virtual worker nodes to determine a KPI of the host's efficiency in executing its share of the map tasks (i.e., particular map tasks of the job on the host). For example, configuration analyzer 130 determines two of the host's virtual worker nodes with most of the slowest map tasks. This KPI is referred to as a host's node duration efficiency in executing its share of the map tasks. This KPI may be represented by “N1:Node-X/host-a; N2:Node-Y/host-a,” where “N1” is the number of the 10 slowest map tasks that are on a virtual worker node X of a host a, “N2” is the number of the 10 slowest map tasks that are on a virtual worker node Y of host a, and virtual worker nodes X and Y are the two top virtual worker nodes with most of the 10 slowest map tasks on host a. Block 310 may be followed by block 312.

In block 312, configuration analyzer 130 aggregates, for each host 102, KPIs of the host's virtual worker nodes to determine a KPI of the host's efficiency in executing its share of the reduce tasks (i.e., particular reduce tasks of the job on the host). For example, configuration analyzer 130 determines this by find two of the host's virtual worker nodes with most of the number of slowest reduce tasks. This KPI is referred to as a host's node duration efficiency in executing its share of the reduce tasks. This KPI may be represented by “n1:Node-x/host-a; n2:Node-y/host-a,” where “n1” is the number of the 10 slowest reduce tasks that are on a virtual worker node x of host a, “n2” is the number of the 10 slowest map tasks that are on a virtual worker node y of host a, and virtual worker nodes x and y are the two top virtual worker nodes with most of the 10 slowest reduce tasks on host a. Block 312 may be followed by block 314. Blocks 308, 310, and 312 correspond to block 208 of method 200 (FIG. 2-1).

In block 314, configuration analyzer 130 uses the KPIs of hosts 102 to determine the least efficient host in executing its share of the local resource tasks and the least efficient host in executing its share of the network dependent tasks. For example, configuration analyzer 130 ranks hosts 102 by the sums of (N1+N2) of their node duration efficiencies in executing their shares of the map tasks and determine a host A with the most of the 10 slowest map tasks. Configuration analyzer 130 also ranks hosts 102 by the sum of (n1+n2) of their node duration efficiencies in executing their shares of the reduced tasks and determine a host B with the most of the 10 slowest reduce tasks. Block 314 may be followed by block 316.

In block 316, configuration analyzer 130 determines if host A is the same as host B. If so, an anomaly may exist in a host or a VM's local resource configuration and block 316 may be followed by block 318. Otherwise, an anomaly may exist in a host or a VM's network configuration and block 316 may be followed by block 328 (FIG. 3-2). Blocks 314 and 316 correspond to block 210 of method 200 (FIG. 2-1).

In block 318, configuration analyzer 130 determines if host A is less busy from executing it share of the local resource tasks and the network dependent tasks than other hosts. For example, configuration analyzer 130 determines if host A′s average CPU utilization is smaller than other hosts. If not, an anomaly may exist in a VM's processor configuration and block 318 may be followed by block 320. Otherwise, an anomaly may exist in a host or a VM's disk configuration and block 318 maybe followed by block 322. Block 318 corresponds to block 212 of method 200 (FIG. 2-1).

In block 320, configuration analyzer 130 reports host A′s busiest virtual worker node as a candidate of processor error. For example, configuration analyzer 130 reports the virtual worker node on host A with the greatest CPU utilization as a candidate of CPU error. Method 300 may end after block 320. Block 320 corresponds to block 214 of method 200 (FIG. 2-1).

In block 322, configuration analyzer 130 determines if host A′s virtual worker nodes have greater variation in their busyness than the other hosts' virtual worker nodes. For example, configuration analyzer 130 determines if host A′s standard deviation of CPU utilizations is greater than other hosts. If so, an anomaly may exist in a VM's disk configuration and block 322 may be followed by block 324. Otherwise, an anomaly may exist in a host's disk configuration and block 322 may be followed by block 326. Block 322 corresponds to block 216 of method 200 (FIG. 2-1).

In block 324, configuration analyzer 130 reports host A′s least efficient virtual worker node in executing its share of the local resource tasks as a candidate of disk configuration error. For example, configuration analyzer 130 reports host A′s virtual worker node with the most of the slowest map tasks as a candidate of disk configuration error. In other words configuration analyzer 130 reports the virtual worker node with the top task execution duration efficiency in executing its share of the map tasks (e.g., report node X with top N:Node-X/host-A). Method 300 may end after block 324. Block 324 corresponds to block 218 of method 200 (FIG. 2-1).

In block 326, configuration analyzer 130 reports host A as a candidate of disk configuration error. Method 300 may end after block 326. Block 326 corresponds to block 220 of method 200 (FIG. 2-1).

In block 328 of FIG. 3-2, configuration analyzer 130 determines if host A has virtual worker nodes with greater variation in their busyness than other hosts' virtual worker nodes. For example, configuration analyzer 130 determines if host A′s standard deviation of CPU utilizations is greater than other hosts. If so, block 328 may be followed by block 330. Otherwise, an anomaly may exist in a host's network configuration and block 328 may be followed by block 334. Block 328 corresponds to block 222 of method 200 (FIG. 2-2).

In block 330, configuration analyzer 130 determines if host A is less busy than other hosts. For example, configuration analyzer 130 determines if host A′s average CPU utilization is less than other hosts. If so, an anomaly may exist in a VM's network configuration and block 330 may be followed by block 332. Otherwise, an anomaly may exist in a host's network configuration and block 330 may be followed by block 334. Block 330 corresponds to block 224 of method 200 (FIG. 2-2).

In block 334, configuration analyzer 130 reports host A′s least efficient virtual worker node in executing its share of the local resource tasks as a candidate of network configuration error. For example, configuration analyzer 130 reports host A′s virtual worker node with the most of the slowest map tasks as a candidate of network configuration error. In other words, configuration analyzer 130 reports the virtual worker node with the top task execution duration efficiency in executing its share of the map tasks (e.g., report node Y with top N:Node-Y/host-A). Method 300 may end after block 334. Block 334 corresponds to block 226 of method 200 (FIG. 2-2).

In block 332, configuration analyzer 130 reports host A as a candidate of network configuration error. Method 300 may end after block 332. Block 334 corresponds to block 228 of method 200 (FIG. 2-2).

The concepts described above may be extended to identify any anomaly in racks where hosts 102 reside. For example, configuration analyzer 130 aggregates, for each rack, KPIs of the rack's hosts to determine a KPI of the rack's busyness, efficiency in executing its share of the map tasks, and efficiency in executing its share of the reduce tasks. Configuration analyzer 130 uses the KPIs of the racks along with the KPIs of hosts 102 and virtual worker nodes 124 to identify any rack that may be a candidate of configuration error and a particular type of configuration error.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

We claim:

1: A method to identify a possible anomaly in a virtual distributed computing system comprising virtual nodes that are virtual machines on hosts, the method comprising:
receiving a trace of a job executed on the virtual distributed computing system and a topology of the virtual distributed computing system, the job comprising local resource tasks and network dependent tasks executed on the virtual nodes, the topology comprising virtual node-to-host mappings;
for each virtual node, determining performance indicators of the virtual node's (1) busyness from executing its share of the local resource tasks and the network dependent tasks, (2) efficiency for executing its share of the local resource tasks, and (3) efficiency for executing its share of the network dependent tasks;
for each host, aggregating performance indicators of the host's virtual nodes to determine the host's (1) busyness from executing its share of the local resource tasks and the network dependent tasks, (2) efficiency for executing its share of the local resource tasks, and (3) efficiency for executing its share of the network dependent tasks;
determining if one of the hosts is least efficient in both executing its share of the local resource tasks and its share of the network dependent tasks;
when one host is least efficient in both executing its share of the local resource tasks and its share of the network dependent tasks:
determining if the one host is less busy from executing it share of the local resource tasks and the network dependent tasks than other hosts;
when the one host is not less busy from executing it share of the local resource tasks and the network dependent tasks than other hosts, reporting a busiest virtual node on the host as a candidate of processor error.

2: The method of claim 1, further comprises:
when the one host is less busy from executing it share of the local resource tasks and the network dependent tasks than other hosts:
determining if the one host's virtual nodes have greater variation in their busyness than the other hosts' virtual nodes; and
when the one host's virtual nodes have greater variation in their busyness than the other hosts' virtual nodes, reporting the one host's least efficient virtual node in executing its share of the local resource tasks as a candidate of disk configuration error.

3: The method of claim 2, further comprises:
when the one host's virtual nodes do not have greater variation in their busyness than the other hosts' virtual nodes, reporting the one host as a candidate of disk configuration error.

4: The method of claim 3, further comprises, when one host is not least efficient in both executing its share of the local resource tasks and its share of the network dependent tasks:
determining if a host that is least efficient in executing its share of the local resource tasks has virtual nodes with greater variation in their busyness than other hosts' virtual nodes;
when the host that is least efficient in executing its share of the local resource tasks has virtual nodes with greater variations in their busyness than other hosts' virtual nodes:
determining if the host that is least efficient in executing its share of the local resource tasks is less busy than other hosts;
when the host that is least efficient in executing its share of the local resource tasks is less busy than other hosts, reporting the host's least efficient in executing its share of the local resource tasks as a candidate of network configuration error.

5: The method of claim 4, further comprises:
when the host that is least efficient in executing its share of the local resource tasks is not less busy than other hosts, reporting the host as a candidate of network configuration error.

6: The method of claim 5, further comprises:
when the host that is least efficient in executing its share of the local resource tasks does not have virtual nodes with greater variation in their busyness than other hosts' virtual nodes, reporting the host as a candidate of network configuration error.

7: The method of claim 1, wherein:
the local resource tasks comprise map tasks;
the network dependent tasks comprise reduce tasks;
each virtual node's performance indicator for efficiency in executing its share of the local resource tasks comprises a number of slowest map tasks on the virtual node; and
each virtual node's key performance indicator for efficiency in executing its share of the network dependent tasks comprises a number of slowest reduce tasks on the virtual node. claim 8: The method of claim 7, wherein:
each host's efficiency in executing its share of the local resource tasks is determined by determining the host's top two virtual nodes with most of the slowest map tasks and summing their numbers of the slowest map tasks on the two virtual nodes; and
each host's efficiency in executing its share of the network dependent tasks is determined by determining the host's top two virtual nodes with most of the number of slowest reduce tasks and summing their numbers of the slowest reduce tasks on the two virtual nodes.

9: The method of claim 8, wherein determining if one host is least efficient in both executing its share of the local resource tasks and its share of the network dependent tasks comprises:
determining a first host with the most of the slowest map tasks;
determining a second host with the most of the slowest reduce tasks; and
determining if the first host is the second host.

10: The method of claim 2, wherein:
the local resource tasks comprise map tasks;
the network dependent tasks comprise reduce tasks; and
each virtual node's performance indicator for busyness from executing its share of the local resource tasks and the network dependent tasks comprises a processor utilization for executing its share of the map tasks and the reduce tasks over a time duration for completing its share of the local resource tasks and the network dependent tasks. claim 11: The method of claim 10, wherein each host's busyness from executing its share of the local resource tasks and the network dependent tasks comprises an average processor utilization and magnitude and distribution of variances of its virtual nodes' processor utilizations.

12: The method of claim 11, wherein:
determining if the one host is less busy from executing it share of the local resource tasks and the network dependent tasks than other hosts comprises comparing their average processor utilizations; and
determining if the one host's virtual nodes have greater variation in their busyness than the other hosts' virtual nodes comprises comparing their standards of deviation.

13: A virtual distributed computing system, comprising:
virtual nodes implemented on hosts;
a configuration analyzer implemented on one of the hosts or a separate host, the configuration analyzer being configured to:
receive a trace of a job executed on the virtual distributed computing system and a topology of the virtual distributed computing system, the job comprising local resource tasks and network dependent tasks executed on the virtual nodes, the topology comprising virtual node-to-host mappings;
for each virtual node, determine performance indicators of the virtual node's (1) busyness from executing its share of the local resource tasks and the network dependent tasks, (2) efficiency for executing its share of the local resource tasks, and (3) efficiency for executing its share of the network dependent tasks;
for each host, aggregate performance indicators of the host's virtual nodes to determine the host's (1) busyness from executing its share of the local resource tasks and the network dependent tasks, (2) efficiency for executing its share of the local resource tasks, and (3) efficiency for executing its share of the network dependent tasks;
determine if one of the hosts is least efficient in both executing its share of the local resource tasks and its share of the network dependent tasks;
when one host is least efficient in both executing its share of the local resource tasks and its share of the network dependent tasks:
determine if the one host is less busy from executing it share of the local resource tasks and the network dependent tasks than other hosts;
when the one host is not less busy from executing it share of the local resource tasks and the network dependent tasks than other hosts, reporting a busiest virtual node on the host as a candidate of processor error.

14: The system of claim 13, wherein the configuration analyzer is configured to:
when the one host is less busy from executing it share of the local resource tasks and the network dependent tasks than other hosts:
determine if the one host's virtual nodes have greater variation in their busyness than the other hosts' virtual nodes; and
when the one host's virtual nodes have greater variation in their busyness than the other hosts' virtual nodes, report the one host's least efficient virtual node in executing its share of the local resource tasks as a candidate of disk configuration error. claim 15: The system of claim 14, wherein the configuration analyzer is configured to:
when the one host's virtual nodes do not have greater variation in their busyness than the other hosts' virtual nodes, report the one host as a candidate of disk configuration error.

16: The system of claim 15, wherein the configuration analyzer is configured to, when one host is not least efficient in both executing its share of the local resource tasks and its share of the network dependent tasks:
determine if a host that is least efficient in executing its share of the local resource tasks has virtual nodes with greater variation in their busyness than other hosts' virtual nodes;
when the host that is least efficient in executing its share of the local resource tasks has virtual nodes with greater variations in their busyness than other hosts' virtual nodes:
determine if the host that is least efficient in executing its share of the local resource tasks is less busy than other hosts;
when the host that is least efficient in executing its share of the local resource tasks is less busy than other hosts, report the host's least efficient in executing its share of the local resource tasks as a candidate of network configuration error.

17: The method of claim 16, wherein the configuration analyzer is configured to:
when the host that is least efficient in executing its share of the local resource tasks is not less busy than other hosts, report the host as a candidate of network configuration error.

18: The system of claim 17, wherein the configuration analyzer is configured to:
when the host that is least efficient in executing its share of the local resource tasks does not have virtual nodes with greater variation in their busyness than other hosts' virtual nodes, report the host as a candidate of network configuration error.

19: The system of claim 13, wherein:
the local resource tasks comprise map tasks;
the network dependent tasks comprise reduce tasks;
each virtual node's performance indicator for efficiency in executing its share of the local resource tasks comprises a number of slowest map tasks on the virtual node;
each virtual node's key performance indicator for efficiency in executing its share of the network dependent tasks comprises a number of slowest reduce tasks on the virtual node;
each host's efficiency in executing its share of the local resource tasks is determined by determining the host's top two virtual nodes with most of the slowest map tasks and summing their numbers of the slowest map tasks on the two virtual nodes;
each host's efficiency in executing its share of the network dependent tasks is determined by determining the host's top two virtual nodes with most of the number of slowest reduce tasks and summing their numbers of the slowest reduce tasks on the two virtual nodes; and
determining if one host is least efficient in both executing its share of the local resource tasks and its share of the network dependent tasks comprises:
determine a first host with the most of the slowest map tasks;
determine a second host with the most of the slowest reduce tasks; and
determine if the first host is the second host.

20: The system of claim 14, wherein:
the local resource tasks comprise map tasks;
the network dependent tasks comprise reduce tasks; and
each virtual node's performance indicator for busyness from executing its share of the local resource tasks and the network dependent tasks comprises a processor utilization for executing its share of the map tasks and the reduce tasks over a time duration for completing its share of the local resource tasks and the network dependent tasks;
each host's busyness from executing its share of the local resource tasks and the network dependent tasks comprises an average processor utilization and magnitude and distribution of variances of its virtual nodes' processor utilizations;
determining if the one host is less busy from executing it share of the local resource tasks and the network dependent tasks than other hosts comprises comparing their average processor utilizations; and
determining if the one host's virtual nodes have greater variation in their busyness than the other hosts' virtual nodes comprises comparing their standards of deviation.

21: A non-transitory computer-readable storage medium encoded with instructions executable by a processor to:
receive a trace of a job executed on a virtual distributed computing system and a topology of the virtual distributed computing system, the job comprising local resource tasks and network dependent tasks executed on virtual nodes that are virtual machines on hosts in the virtual distributed computing system, the topology comprising virtual node-to-host mappings;
for each virtual node, determine performance indicators of the virtual node's (1) busyness from executing its share of the local resource tasks and the network dependent tasks, (2) efficiency for executing its share of the local resource tasks, and (3) efficiency for executing its share of the network dependent tasks;
for each host, aggregate performance indicators of the host's virtual nodes to determine the host's (1) busyness from executing its share of the local resource tasks and the network dependent tasks, (2) efficiency for executing its share of the local resource tasks, and (3) efficiency for executing its share of the network dependent tasks;
determine if one of the hosts is least efficient in both executing its share of the local resource tasks and its share of the network dependent tasks;
when one host is least efficient in both executing its share of the local resource tasks and its share of the network dependent tasks:
determine if the one host is less busy from executing it share of the local resource tasks and the network dependent tasks than other hosts;
when the one host is not less busy from executing it share of the local resource tasks and the network dependent tasks than other hosts, report a busiest virtual node on the host as a candidate of processor error.

22: The non-transitory computer-readable storage medium of claim 21, further comprising instructions executable by the processor to:
when the one host is less busy from executing it share of the local resource tasks and the network dependent tasks than other hosts:
determine if the one host's virtual nodes have greater variation in their busyness than the other hosts' virtual nodes; and
when the one host's virtual nodes have greater variation in their busyness than the other hosts' virtual nodes, report the one host's least efficient virtual node in executing its share of the local resource tasks as a candidate of disk configuration error.

23: The non-transitory computer-readable storage medium of claim 22, further comprising instructions executable by the processor to:
when the one host's virtual nodes do not have greater variation in their busyness than the other hosts' virtual nodes, report the one host as a candidate of disk configuration error.

24: The non-transitory computer-readable storage medium of claim 23, further comprising instructions executable by the processor to, when one host is not least efficient in both executing its share of the local resource tasks and its share of the network dependent tasks:
determine if a host that is least efficient in executing its share of the local resource tasks has virtual nodes with greater variation in their busyness than other hosts' virtual nodes;
when the host that is least efficient in executing its share of the local resource tasks has virtual nodes with greater variations in their busyness than other hosts' virtual nodes:
determine if the host that is least efficient in executing its share of the local resource tasks is less busy than other hosts;
when the host that is least efficient in executing its share of the local resource tasks is less busy than other hosts, report the host's least efficient in executing its share of the local resource tasks as a candidate of network configuration error. claim 25: The non-transitory computer-readable storage medium of claim 24, further encoded with instructions executable by the processor to:
when the host that is least efficient in executing its share of the local resource tasks is not less busy than other hosts, report the host as a candidate of network configuration error.

26: The non-transitory computer-readable storage medium of claim 25, further comprising instructions executable by the processor to:
when the host that is least efficient in executing its share of the local resource tasks does not have virtual nodes with greater variation in their busyness than other hosts' virtual nodes, report the host as a candidate of network configuration error.

27: The non-transitory computer-readable storage medium of claim 21, wherein:
the local resource tasks comprise map tasks;
the network dependent tasks comprise reduce tasks;
each virtual node's performance indicator for efficiency in executing its share of the local resource tasks comprises a number of slowest map tasks on the virtual node;
each virtual node's key performance indicator for efficiency in executing its share of the network dependent tasks comprises a number of slowest reduce tasks on the virtual node;
each host's efficiency in executing its share of the local resource tasks is determined by determining the host's top two virtual nodes with most of the slowest map tasks and summing their numbers of the slowest map tasks on the two virtual nodes;
each host's efficiency in executing its share of the network dependent tasks is determined by determining the host's top two virtual nodes with most of the number of slowest reduce tasks and summing their numbers of the slowest reduce tasks on the two virtual nodes; and
determining if one host is least efficient in both executing its share of the local resource tasks and its share of the network dependent tasks comprises:
determine a first host with the most of the slowest map tasks;
determine a second host with the most of the slowest reduce tasks; and
determine if the first host is the second host.

28: The non-transitory computer-readable storage medium of claim 22, wherein:
the local resource tasks comprise map tasks;
the network dependent tasks comprise reduce tasks; and
each virtual node's performance indicator for busyness from executing its share of the local resource tasks and the network dependent tasks comprises a processor utilization for executing its share of the map tasks and the reduce tasks over a time duration for completing its share of the local resource tasks and the network dependent tasks;
each host's busyness from executing its share of the local resource tasks and the network dependent tasks comprises an average processor utilization and magnitude and distribution of variances of its virtual nodes' processor utilizations;
determining if the one host is less busy from executing it share of the local resource tasks and the network dependent tasks than other hosts comprises comparing their average processor utilizations; and
determining if the one host's virtual nodes have greater variation in their busyness than the other hosts' virtual nodes comprises comparing their standards of deviation.
